(19) United States
(12) Patent Application Publication
(10) Pub. No.: US 2018/0372329 A1
(43) Pub. Date: Dec. 27, 2018

(54) Stovetop Burner Protection System

(71) Applicant: Bikram Shrestha, Oklahoma City, OK (US)

(72) Inventor: Bikram Shrestha, Oklahoma City, OK (US)

(21) Appl. No.: 15/723,556

(22) Filed: Oct. 3, 2017

Related U.S. Application Data
(60) Provisional application No. 62/523,373, filed on Jun. 22, 2017.

(51) Int. Cl. F24C 15/10; F24C 3/12; F24C 15/12

(52) U.S. Cl. CPC F24C 15/101; F24C 3/122; B32B 3/263; F24C 15/12; F24C 15/105

(57) ABSTRACT

A stovetop burner protector, in some embodiments, may provide for a covering device for stoves that may comprise a heat-conducting plate ringed by a high heat-resistant element, which may be configured to cover one or more stovetop burners. The present invention's heat-resistant element may be configured so as to catch or divert the path of any liquids or solids that may be dispersed by the cooking process. At least one small dome-shaped opening on the side of the heat-resistant element may be configured to let out some or all of the hot air.

### CROSS-REFERENCE TO RELATED APPLICATION

This application claims priority to U.S. Provisional Application No. 62/523,373 filed on Jun. 22, 2017, the disclosure of which, including any materials incorporated by reference therein, is incorporated herein by reference in its entirety.

### TECHNICAL FIELD

The present invention relates generally to the field of cooking accessories and more specifically relates to a stovetop burner protection system.

### BACKGROUND

Nearly all adults have let stove top spills and food bits get past them when they are cooking in the kitchen. With current stovetop burner designs, this result is nearly inevitable. However, this result could be prevented through a stove covering device that avoids any spillage from the stove area and ensures that no liquid or food gets past it. Not only does would such a device help guard from fire hazards, but it would also help with overall cleanliness in a user's kitchen by blocking out any pieces of food that could get trapped. Therefore, a need exists for such a device.

Attempts have been made, although unsuccessfully, to meet this need. One illustrative attempt can be seen with respect to U.S. Pat. No. 6,399,924, which generally discloses a cooktop covering device that covers one or more burners. While this disclosure does provide for burner covering, its hinged cap-like design fails to provide adequate coverage for areas beyond the burner's edge, and also makes it likely that food waste can get in the hinge, making the device less effective.

Another attempt to meet this need can be seen with respect to U.S. Pat. No. 6,105,811, which generally discloses a concave pan cover addition that appears intended to trap errant food waste produced by cooking. While this disclosure does provide for a food waste collection and trapping function, its upward-facing concave design makes it difficult to use with certain sized pans, and may even burn a user when the user sets a pan on it without properly gauging the location of the device's periphery.

Another attempt can be seen with respect to U.S. Pat. No. 5,353,781, which generally discloses a fire-retardant cloth-like cover that can be laid over burners while cooking. While this disclosure does provide for a cooktop-covering solution, it is intended for burners not in use, which limits its utility.

As can be seen, various attempts have been made to solve the problems which may be found in the related art but have been unsuccessful. A need exists for a new stovetop burner protection system to avoid the challenges and problems with the prior art.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a “burner,” flame,” and so forth, are herein meant to include or encompass all equivalents for such elements. For example, in addition to a “flame,” any heat applied to a surface for the purpose of heating a stovetop item is also contemplated by the present invention. Such equivalents are contemplated for each element named in its particular herein.

The present invention relates to a stovetop burner protector that overcomes the deficiencies of the prior art. It is contemplated that the present invention may provide a stovetop burner protector that enables a user to cook over a stovetop and use one or more stovetop burners without spilling food or liquids onto the stovetop or otherwise dirtying or damaging the stovetop.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel solution for cooking. The general purpose of the present invention, which shall be described subsequently in greater detail, is to enable a user to cook using one or more stovetop burners without creating a mess. The features of the invention are believed to be novel and to have been particularly pointed out and distinctly claimed in the concluding portion of the specification. These and other features, aspects, and advantages of the present invention will become better understood with reference to the following drawing and detailed description.

In one embodiment, the present invention may provide for a covering device for stoves that may comprise a steel plate (also called “hot plate” herein) ringed by high heat-resistant elastomer, which may go over the electric or gas stovetop area. It is contemplated that the heat-conducting element may transfer heat from a stove's burner to a pan, and as such may serve as a heat-conducting intermediate in the cooking process. The present invention's heat-resistant elastomer may be configured so as to catch any liquids or solids that may be dispersed by the cooking process. A small dome-shaped opening on the side of the elastomer portion may be configured to let out some or all of the expanded hot air. In some embodiments, when a pan or other cookware is set on top of the center heat conducting element, the elastomer may spread and “fall down” on top of the stove while the steel plate sits on top of the stove's burner, thereby being in position to catch the aforementioned liquids or solids. The present invention is meant to detain any possible fire hazards that can come as a result of a spill or of food debris left behind.

Additionally, the present invention may provide for an alternative embodiment which is larger and square, and in some embodiments, may be flipped upside down without the heat vent, which can go over a gas stove. In such an embodiment, there may also be grooves on the bottom of the steel plate to keep it from moving. One reason for this design is that gas stoves create bigger fire hazards due to the fire. Most gas stoves are square, so the stove cover may go on top of it as a U-shaped device. The cooking utensil may rest on top of the cover. Likewise, any spillage may fall on the cover and collect on the cover, such that, in some embodiments, little to no spillage may fall on the fire and create a fire hazard within that kitchen.

In some embodiments, the center element may be a heat-conducting element other than steel, and the ring may be comprised of material other than elastomer. Additionally, the present invention may provide for more vents, grooved portions in addition to those named, hotter or cooler zones within the center heat-conducting element, lid embodiments, and any other modification necessary to effectuate the purpose(s) of the present disclosure.

In some embodiments, a stovetop burner may be provided in combination with the burner protector element. It is contemplated that the stovetop burner may be electrically powered by either battery, solar, or grid power, and may heat a center metal coil. In some embodiments, the stovetop burner may provide for a center housing (or “stand-alone stove top”) that may provide for at least one light and at least one temperature knob. In some embodiments, the light may indicate that the unit is on, that the unit is hot, or both. In some embodiments, the temperature knob may provide a dial wherein a user may control the amount of heat generated by the metal coil.

More specifically, in some embodiments, a stovetop burner protection system may comprise at least one plate having at least one upper surface, at least one lower surface, and at least one edge, and at least one heat resistant element, wherein the at least one heat resistant element is fixedly connected to the at least one edge, and wherein the at least one heat resistant element is configured to cover a stovetop burner. In some embodiments, the at least one plate may be a steel plate, but may in other embodiments be made from any heat-conducting element, as discussed elsewhere herein. Additionally, in some embodiments, the heat resistant element may be high-heat silicone, high-heat elastomer, or any other material or element, or combination of materials or elements, that may be heat resistant and may prevent materials from damaging a stovetop. Furthermore, the heat resistant element may further comprise at least one heat vent. Moreover, in some embodiments, the plate may be circular, square, U-shaped, or any other shape. In some embodiments, particularly, although not exclusively, when configured for use with gas heating elements, the present invention may provide for one or more raised portions disposed on the at least one lower surface of the at least one plate, particularly although not exclusively in embodiments wherein the plate is U-shaped.

Additionally, and also more specifically, in some embodiments, the present invention may comprise at least one stovetop, the at least one stovetop comprising at least one metal coil, at least one light indicator, at least one temperature control knob, and at least one heating source, wherein the heating source is configured to heat the at least one metal coil, in combination with a plate and heat resistant element as generally disclosed throughout the present disclosure. In some embodiments, the at least one heating element may be an electrical source electrically coupled to the at least one metal coil. It is contemplated that in such embodiments, the at least one stovetop may be either battery, grid, or solar powered, and may heat be configured to heat the coil by means of electricity, as electrical burners are known in the art, and in any form known in the art. In some embodiments, the at least one heating element may be a gas-burning element, wherein the gas-burning element is configured to heat the at least one metal coil.

In such embodiments, the gas-burning element may be configured as a gas line from a central source connected to a burner, a propane tank connected to a burner, or any gas-burning element known in the art capable of heating a metal coil.

The unique features of the present invention may provide the following benefits for one or more consumers: it may stop one or more spills from going on the stove where it is hard to clean, and it may increase kitchen safety by decreasing the chance of a fire hazard due to a spillage or food part coming into contact with the stove top area.

### BRIEF DESCRIPTION OF THE DRAWINGS

These and other features, aspects and advantages of the present invention will become better understood with regard to the following description, appended claims, and accompanying figures where:

FIG. 1 shows a top-perspective view of a stovetop burner protection system in accordance with one embodiment of the invention.

FIG. 2 shows an additional top-side perspective view of a stovetop burner protection system in accordance with one embodiment of the invention.

FIG. 3 shows an additional top-side perspective view of a stovetop burner protection system in accordance with one embodiment of the invention.

### DETAILED DESCRIPTION

The present invention overcomes the limitations of the prior art by providing a new and more effective stovetop burner protector.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

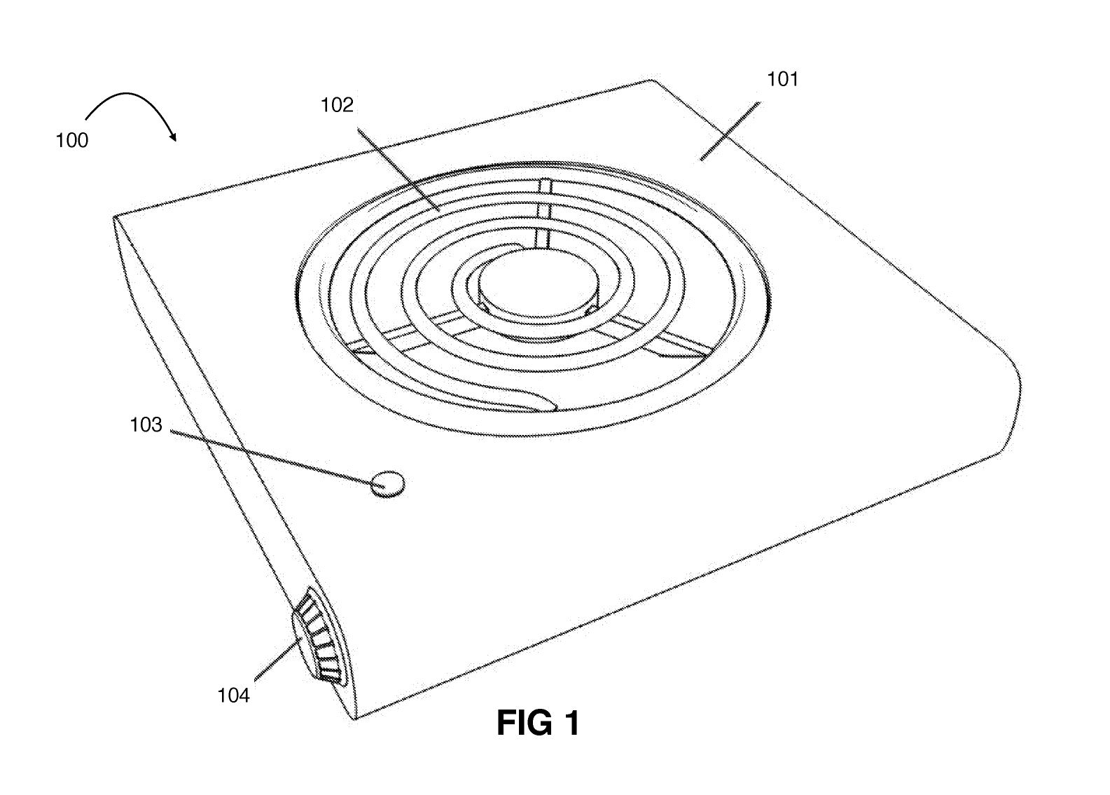

Turning attention to FIG. 1, a top-perspective view of a stovetop burner protection system in accordance with one embodiment of the invention is shown. In the embodiment depicted, a viewer may perceive stovetop burner protection system 100, stand-alone stove top 101, metal coil 102, light indicator 103, and temperature knob 104.

As mentioned above, stand-alone stove top 101 can be of any shape known in the art. For example, in the embodiment shown in FIG. 1, stand-alone stove top 101 contains one metal coil 102, one light indicator 103, and one temperature knob 104. In some embodiments, stand-alone stove top 101 may provide for two or more metal coils 102, and may provide for two or more light indicators 103, and temperature knobs 104 as well. Correspondingly, stand-alone stove top 101 may be of any shape, thickness, material, or other properties as may enable the present invention to function as intended, including but not limited to the shapes of a square, rectangle, oval or circle, the thickness of a half-inch to three inches, and may be composed of a material or combination of materials of plastic, metal, or ceramic nature. It is also contemplated that in some embodiments, stand-alone stove top 101 may be configured for use with electricity or gas as the means for heating metal coil 102.

Although designated as “metal,” metal coil 102 may also be of any material, shape, weight, or other properties known in the art. For example, metal coil 102 may be in the shape of a square, rectangle, oval or circle, may have the thickness of a few millimeters to an inch, and may be composed of a material or combination of materials of plastic, metal, or ceramic nature. Additionally, the present invention may provide for one, two, or three or more light indicators 103, and may provide for one, two, or three or more temperature knobs 104, for example, in embodiments having one, two, or three or more metal coils 102.

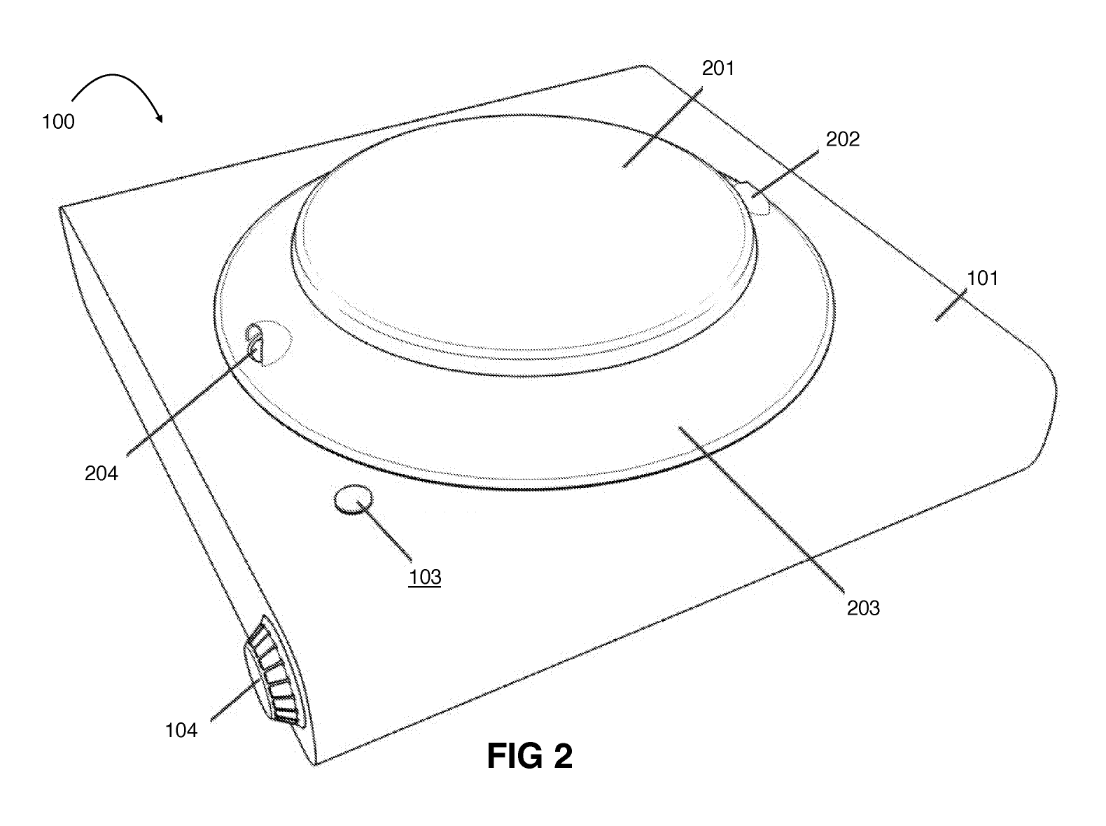

With respect to FIG. 2, an additional top-side perspective view of a stovetop burner protection system in accordance with one embodiment of the invention is shown. In the embodiment depicted, a viewer may perceive hot plate 201, first air vent 202, silicon or elastomer ring 203, and second air vent 204, as well as stovetop burner protection system 100, stand-alone stove top 101, light indicator 103, and temperature knob 104.

In some embodiments, hot plate 201 may be metal, ceramic, or any other heat-transmitting element, material, or combination of elements or materials, known in the art. Hot plate 201 may also be of any shape or thickness known in the art. For example, hot plate 201 may be circular, U-shaped, square, oval, rectangular, and so forth. Hot plate 201 may also provide for one or more raised portions, one or more depressed portions, one or more transparent portions, or one or more mesh portions on the upper side, lower side, or both sides of hot plate 201. However, it is generally contemplated that cavities as such should be avoided in hot plate 201, so that no material may pass through the hot plate 201.

Remaining with FIG. 2, in the embodiment depicted, a viewer may perceive first air vent 202 and second air vent 204. In some embodiments, either first air vent 202, second air vent 204, or both, may be a small dome shaped opening in silicon or elastomer ring 203, wherein the either first air vent 202, second air vent 204, or both, may be configured to enable heat and/or hot air to escape from the area underneath hot plate 201 and silicon or elastomer ring 203.

Additionally, in FIG. 2, a viewer may perceive silicon or elastomer ring 203. In some embodiments, silicon or elastomer ring 203 may be comprised of any heat-resistant element, material, or combination of elements or materials. By way of illustration and not limitation, silicon or elastomer ring 203 may be composed of high-heat resistant elastomer. In some embodiments, silicon or elastomer ring 203 may be flexible and may retain a position of co-planar with hot plate 201, or may “fall down” to a lower plane than hot plate 201, or onto stove top 101, such as when hot plate 201 rests on an elevated metal coil 102. In some embodiments, a user may be required to position silicon or elastomer ring 203 as desired, whereas in other embodiments, silicon or elastomer ring 203 may be configured to either remain coplanar with hot plate 201 or to “fall down” on its own depending on the heat of hot plate 201, metal coil 102, or other heating surface.

As may be discerned from FIG. 2, silicon or elastomer ring 203 may provide for a raised-hood shaped opening or open-sided dome shaped opening within silicon or elastomer ring 203 that may be configured to enable either first air vent 202, second air vent 204, or both, to vent hot air from underneath silicon or elastomer ring 203. In some embodiments, as shown in FIG. 2, the raised-hood shaped opening or open-sided dome shaped opening that surrounds first air vent 202, second air vent 204, or both, may be configured to account for the flow of liquids or solids that may slide down the surface of silicon or elastomer ring 203. In the embodiment shown, the portions of silicon or elastomer ring 203 that surround first air vent 202, second air vent 204, or both, are configured to disperse or otherwise redirect the flow of liquids or solids that may slide down the surface of silicon or elastomer ring 203 to either side of first air vent 202, second air vent 204, or both, so as to prevent any such substances from passing into and under silicon or elastomer ring 203.

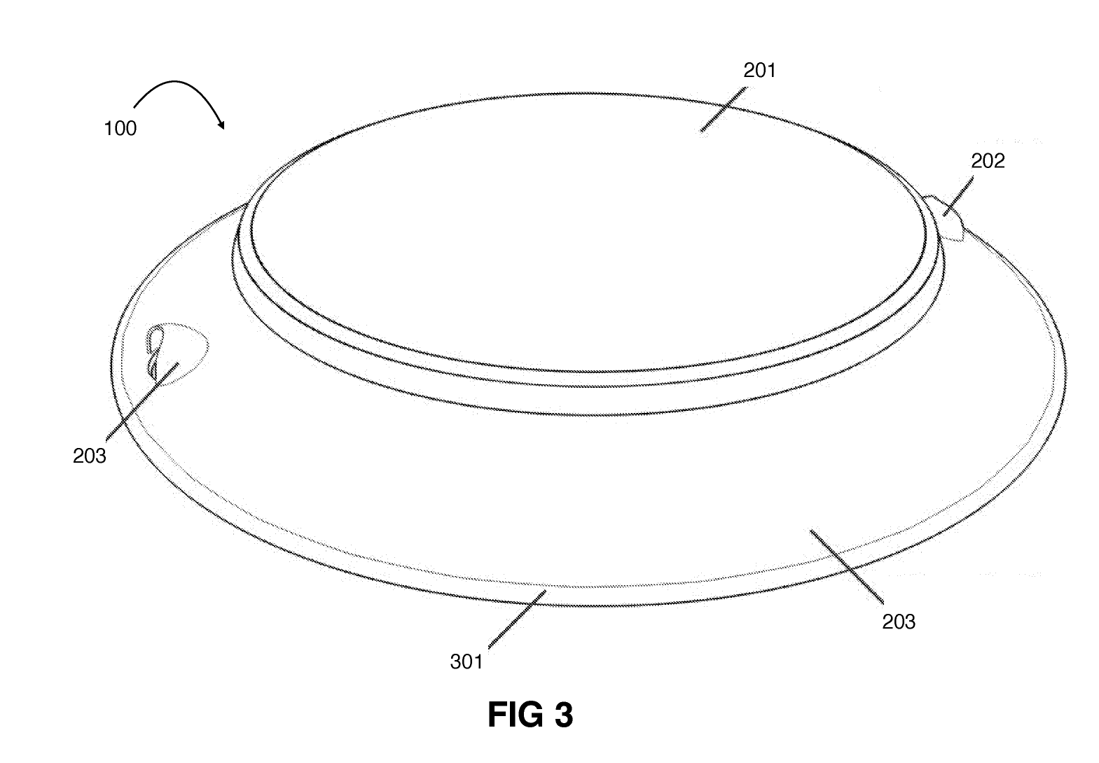

With respect to FIG. 3, an additional top-side perspective view of a stovetop burner protection system in accordance with one embodiment of the invention is shown. In the embodiment depicted, a viewer may perceive sealing edge 301, along with stovetop burner protection system 100, stand-alone stove top 101, light indicator 103, and temperature knob 104, hot plate 201, first air vent 202, silicon or elastomer ring 203, and second air vent 204.

In the embodiment disclosed in FIG. 3, sealing edge 301 is shown as a circular edge or edge element ringing also-circular silicon or elastomer ring 203. In embodiments wherein silicon or elastomer ring 203 is not circular, it is contemplated that sealing edge 301 will not be circular as generally shown in FIG. 3, but will instead provide the lowest point and/or point of contact between silicon or elastomer ring 203 and stove top 101 or other lower surface. Any degree of interaction between silicon or elastomer ring 203 and stove top 101 or other lower surface is contemplated, from a light resting to a full airtight seal. In some embodiments, sealing edge 301 may provide enough contact with stove top 101 or other surface to prevent and liquids or solids that may be flowing or otherwise passing down silicon or elastomer ring 203 from entering the area underneath silicon or elastomer ring 203.

### Conclusions, Ramifications, and Scope

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the stovetop burner protection system generally described herein has been disclosed in connection with a number of embodiments shown and described in detail, various modifications should be readily apparent to those of skill in the art.

What is claimed is:

1. A stovetop burner protection system, comprising:
at least one plate having at least one upper surface, at least one lower surface, and at least one edge; and
at least one heat resistant element, wherein the at least one heat resistant element is fixedly connected to the at least one edge, and wherein the at least one heat resistant element is configured to cover a stovetop burner.

2. The stovetop burner protection system of claim 1, wherein the at least one plate is a steel plate.

3. The stovetop burner protection system of claim 1, wherein the heat resistant element is high-heat silicone.

4. The stovetop burner protection system of claim 1, wherein the heat resistant element is high-heat elastomer.

5. The stovetop burner protection system of claim 1, wherein the heat resistant element further comprises at least one heat vent.

6. The stovetop burner protection system of claim 1, wherein the plate is circular.

7. The stovetop burner protection system of claim 1, wherein the plate is square.

8. The stovetop burner protection system of claim 1, wherein the plate is U-shaped.

9. The stovetop burner protection system of claim 1, further comprising at least one raised portion disposed on the at least one lower surface of the at least one plate.

10. A stovetop burner protection system, comprising:
at least one stovetop, the at least one stovetop comprising;
at least one metal coil;
at least one light indicator;
at least one temperature control knob; and
at least one heating source, wherein the heating source is configured to heat the at least one metal coil;
at least one plate having at least one upper surface, at least one lower surface, and at least one edge; and
at least one heat resistant element, wherein the at least one heat resistant element is fixedly connected to the at least one edge, and wherein the at least one heat resistant element is configured to cover a stovetop burner.

11. The stovetop burner protection system of claim 10, wherein the at least one heating element is an electrical source electrically coupled to the at least one metal coil.

12. The stovetop burner protection system of claim 10, wherein the at least one heating element is a gas-burning element, wherein the gas-burning element is configured to heat the at least one metal coil.

13. The stovetop burner protection system of claim 12, further comprising at least one raised portion disposed on the at least one lower surface of the at least one plate.

14. The stovetop burner protection system of claim 10, wherein the at least one plate is a steel plate.

15. The stovetop burner protection system of claim 10, wherein the heat resistant element is high-heat silicone.

16. The stovetop burner protection system of claim 10, wherein the heat resistant element is high-heat elastomer.

17. The stovetop burner protection system of claim 10, wherein the heat resistant element further comprises at least one heat vent.

18. The stovetop burner protection system of claim 10, wherein the plate is circular.

19. The stovetop burner protection system of claim 10, wherein the plate is square.

20. The stovetop burner protection system of claim 10, wherein the plate is U-shaped.
